(19) United States
(12) Patent Application Publication
(10) Pub. No.: US 2025/0383243 A1
(43) Pub. Date: Dec. 18, 2025

(54) TEMPERATURE SENSOR AND OPERATING METHOD THEREOF

(71) Applicant: PIXART IMAGING INC., Hsin-Chu County (TW)

(72) Inventor: Chung-Min THOR, Penang (MY)

(21) Appl. No.: 18/743,108

(22) Filed: Jun. 14, 2024

(51) Int. Cl. G01K 15/00; G01K 7/34

(52) U.S. Cl. CPC G01K 15/005; G01K 7/34; G01K 15/007

(57) ABSTRACT

There is provided a temperature sensor including a first capacitor bank, a second capacitor bank, a first comparator and a second comparator. In a calibration step, the first comparator compares a first charged voltage of the first capacitor bank with a first group of voltage thresholds to determine conducted capacitors in the first capacitor bank, and the second comparator compares a second charged voltage of the second capacitor bank with a second group of voltage thresholds to determine conducted capacitors in the second capacitor bank. By using the calibration step, the first charged voltage and the second charged voltage across the wafer fabrication process are more consistent and predictable.

### FIELD OF THE DISCLOSURE

This disclosure generally relates to a temperature sensor and, more particularly, to a temperature sensor and an operating method thereof that reduce the measurement error caused by variations of wafer fabrication process and temperatures to be measured.

### BACKGROUND OF THE DISCLOSURE

It is known that values measured by the traditional temperature sensor can be changed across wafer fabrication process and temperatures to be measured such that the measurement error is induced. Therefore, a temperature sensor that can eliminate the influence of wafer fabrication process and temperatures to be measured is required.

The information disclosed in the Related Art herein is merely intended to increase understanding of the general background of the invention and should not be taken as an admission or in any way implied that the relevant information constitutes prior art that is already known to a person of ordinary skill in the art.

### SUMMARY

Accordingly, the present disclosure provides a temperature sensor and an operating method thereof that extend a pulse length of a measurement signal and a counting value of the measurement signal by switching a combination of capacitors.

The present disclosure provides a temperature sensor and an operating method thereof that reduce the measurement error without increasing a design complexity and an occupied area in a chip.

The present disclosure provides a temperature sensor and an operating method thereof adapted to measure a wide temperature range.

The present disclosure provides a temperature sensor including a first comparator, a second comparator, a first capacitor bank, a second capacitor bank, a first current source, a second current source, a first group of predetermined voltages and a second group of predetermined voltages. The first capacitor bank is coupled to first input terminals of the first comparator and the second comparator. The second capacitor bank is coupled to the first input terminals of the first comparator and the second comparator. The first current source is configured to charge the first capacitor bank using a first current. The second current source is configured to charge the second capacitor bank using a second current. The first group of predetermined voltages is configured to be coupled to second input terminals of the first comparator and the second comparator. The second group of predetermined voltages is configured to be coupled to the second input terminals of the first comparator and the second comparator.

The present disclosure further provides a temperature sensor including a first comparator, a second comparator, a first capacitor bank, a second capacitor bank, a first current source, a second current source, a first group of predetermined voltages and a second group of predetermined voltages. The first capacitor bank is coupled to a first input terminal of the first comparator. The second capacitor bank is coupled to a first input terminal of the second comparator. The first current source is configured to charge the first capacitor bank using a first current. The second current source is configured to charge the second capacitor bank using a second current. The first group of predetermined voltages is configured to be coupled to a second input terminal of the first comparator. The second group of predetermined voltages is configured to be coupled to a second input terminal of the second comparator.

The present disclosure further provides an operating method of a temperature sensor. The temperature sensor includes a first capacitor bank, a second capacitor bank, a first current source and a second current source. The operating method includes the steps of: measuring a first current of the first current source and a second current of the second current source respectively using a tester; conducting first parts of capacitors in the first capacitor bank and the second capacitor bank in temperature measurement upon the first current being larger than a first maximum current and the second current being larger than a second maximum current; and conducting second parts of capacitors, different from the first parts of capacitors, in the first capacitor bank and the second capacitor bank in the temperature measurement upon the first current being smaller than a first minimum current and the second current being smaller than a minimum maximum current.

### BRIEF DESCRIPTION OF DRAWINGS

Other objects, advantages, and novel features of the present disclosure will become more apparent from the following detailed description when taken in conjunction with the accompanying drawings.

FIG. 1 is a schematic diagram of a temperature sensor according to a first embodiment of the present disclosure.

FIG. 2A is a schematic diagram of charged voltages of a temperature sensor according to a first embodiment of the present disclosure.

FIG. 2B is a schematic diagram of a temperature signal outputted by a temperature sensor according to a first embodiment of the present disclosure.

FIG. 3 is a schematic diagram of measurement results at different corners of a temperature sensor according to a first embodiment of the present disclosure.

FIGS. 4A and 4B are schematic diagrams of a temperature sensor according to a second embodiment of the present disclosure.

FIG. 5 is a schematic diagram of selecting the connection of capacitor banks of a temperature sensor according to a second embodiment of the present disclosure.

FIG. 6 is a schematic diagram of measurement results at different corners of a temperature sensor according to a second embodiment of the present disclosure.

FIG. 7 is a schematic diagram of a temperature sensor according to a third embodiment of the present disclosure.

FIG. 8 is a flow chart of an operating method of a temperature sensor according to a third embodiment of the present disclosure.

### DETAILED DESCRIPTION OF THE DISCLOSURE

It should be noted that, wherever possible, the same reference numbers will be used throughout the drawings to refer to the same or like parts.

One objective of the present disclosure is to provide a temperature sensor and an operating method thereof that measure steady voltages of capacitor banks in a calibration mode at first, and then determine a number of capacitors in the capacitor banks to be conducted in a measurement mode according to a comparison result of comparing the steady voltages and predetermined voltage groups. In the present disclosure, the steady voltages are measured inside or outside a chip of the temperature sensor.

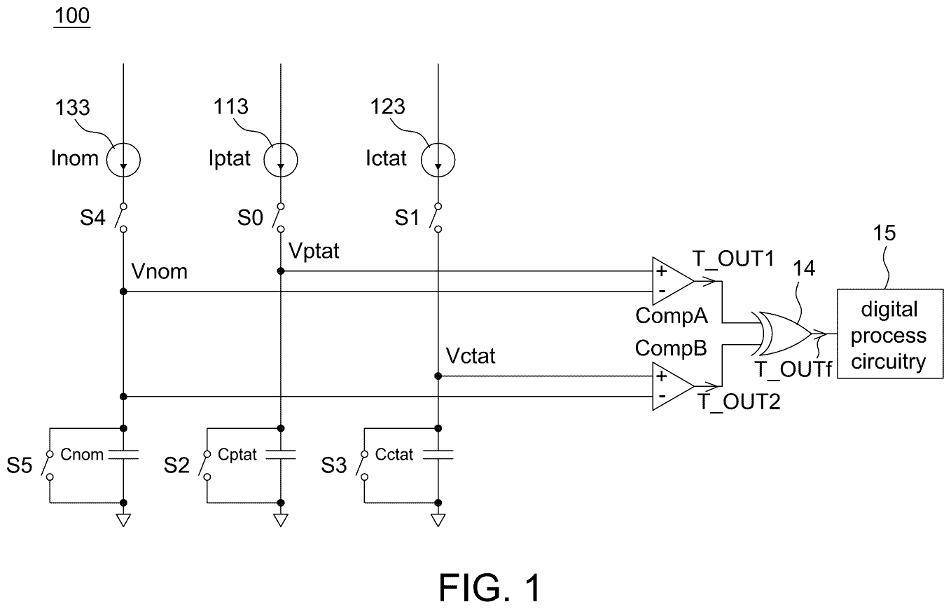

Please refer to FIG. 1, it is a schematic diagram of a temperature sensor 100 according to a first embodiment of the present disclosure. The temperature sensor 100 includes a temperature sensing circuit and a digital processing circuitry 15 coupled to each other. In one aspect, the temperature sensing circuit is located inside a chip of the temperature sensor 100, and the digital processing circuitry 15 is located outside the chip of the temperature sensor 100. The digital processing circuitry 15 is electrically connected to pins or pads of the chip to communicate thereto to be electrically coupled to the temperature sensing circuit. The digital processing circuitry 15 includes, for example, a digital signal processor (DSP), a micro controller unit (MCU), a micro processor unit (MPU) or a central processing unit (CPU), but not limited thereto. In another aspect, the digital processing circuitry 15 is located inside the chip of the temperature sensor 100.

The temperature sensing circuit includes a first capacitor Cptat, a first current source 113, a second capacitor Cctat, a second current source 123, a third capacitor Cnom, a third current source 133, a first comparator CompA, a second comparator CompB and an exclusive OR (XOR) gate 14. In one aspect, the temperature sensing circuit further includes multiple switches S0 to S5. The chip of the temperature sensor 100 includes, for example, an application specific integrated circuit (ASIC) or a field programmable gate array (FPGA) for controlling ON/OFF of the switches S0 to S5.

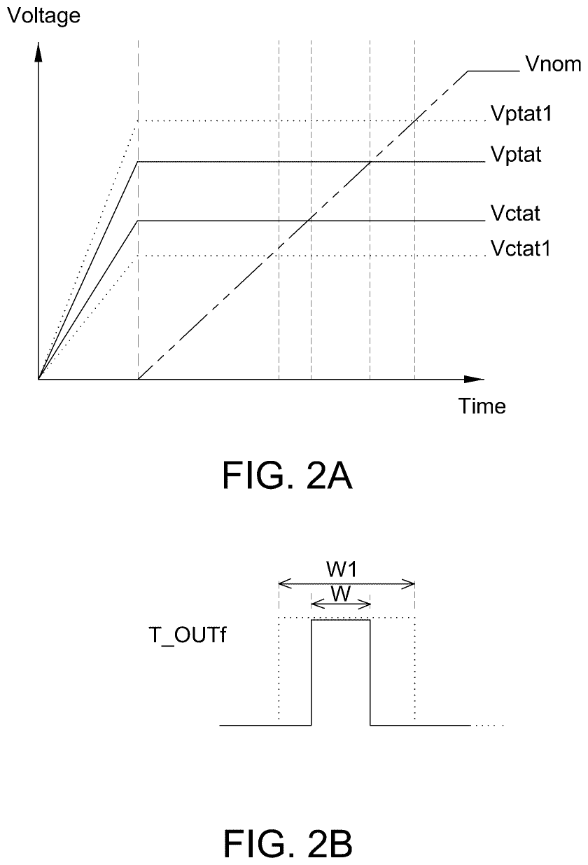

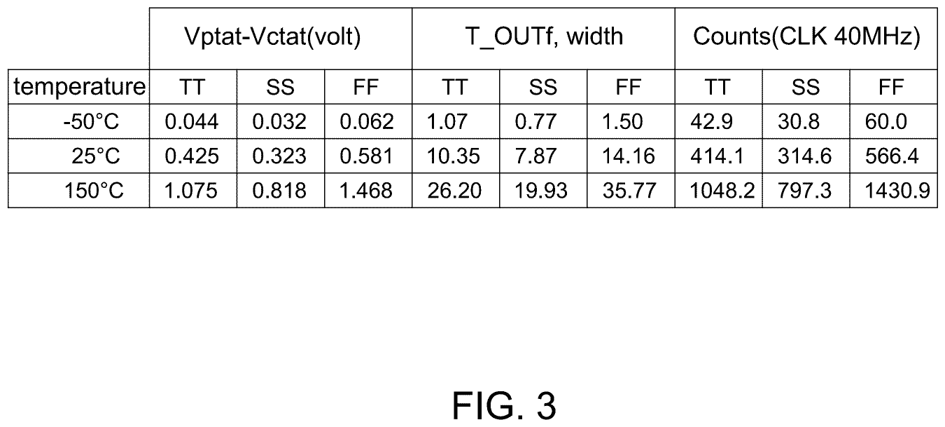

Please refer to FIG. 2A, it is a schematic diagram of charged voltages of the temperature sensor 100 according to a first embodiment of the present disclosure. At a first temperature, the first current source 113 charges the first capacitor Cptat to a first steady voltage Vptat using a first current Iptat when the switch S0 is conducted; the second current source 123 charges the second capacitor Cctat to a second steady voltage Vctat using a second current Ictat when the switch S1 is conducted; the third current source 133 charges the third capacitor Cnom to a third steady voltage Vnom using a third current Inom when the switch S4 is conducted; and meanwhile the switches S2, S3 and S5 are not conducted in charging the first capacitor Cptat, the second capacitor Cctat and the third capacitor Cnom. At a second temperature higher than the first temperature, the first current source 113 charges the first capacitor Cptat to a first steady voltage Vptat1 using the first current Iptat when the switch S0 is conducted; the second current source 123 charges the second capacitor Cctat to a second steady voltage Vctat1 using the second current Ictat when the switch S1 is conducted. The difference between Vptat and Vptat1 and between Vctat and Vctat1 are due to the Iptat and Ictat values varying a lot across wafer fabrication process and temperatures.

A non-inverting input terminal of the first comparator CompA receives the first steady voltage Vptat or Vptat1, and an inverting input terminal of the first comparator CompA receives the third steady voltage Vnom. A non-inverting input terminal of the second comparator CompB receives the second steady voltage Vctat or Vctat1, and an inverting input terminal of the second comparator CompB receives the third steady voltage Vnom. Preferably, the third steady voltage Vnom is higher than the first steady voltage Vptat or Vptat1 as well as the second steady voltage Vctat or Vctat1.

When a voltage of the third capacitor Cnom is charged to exceed the first steady voltage Vptat or Vptat1, a first comparison output T_OUT1 of the first comparator CompA is triggered to low; and when the voltage of the third capacitor Cnom is charged to exceed the second steady voltage Vctat or Vctat1, a second comparison output T_OUT2 of the second comparator CompB is triggered to low. The XOR gate 14 receives the comparison outputs T_OUT1 and T_OUT2 to generate a temperature signal T_OUTf as shown in FIG. 2B.

The digital processing circuitry 15 counts a width W (corresponding to the first temperature) or W1 (corresponding to the second temperature) of the temperature signal T_OUTf using a clock signal having a predetermined frequency to generate a counting value, which reflects a measured temperature. For example, the measured temperature is higher when the counting value is higher.

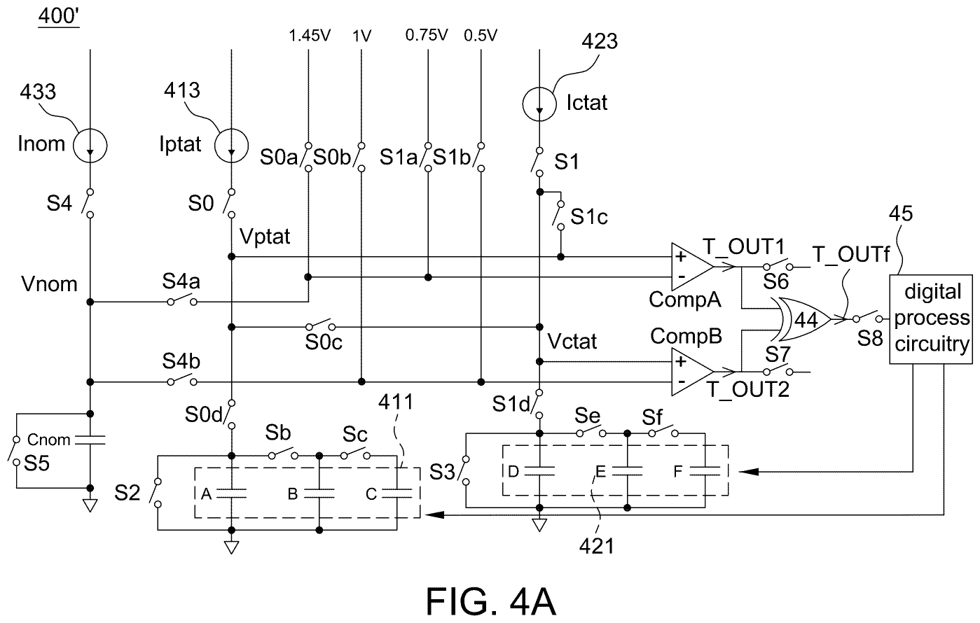

However, the wafer fabrication process variations and the temperature to be measured can affect the counting value, especially when the temperature to be measured is very low. The low counting value generated by the digital processing circuitry 15 can degrade the calculation accuracy of the digital processing circuitry 15. Referring to FIG. 3 for example, it shows counting values (e.g., shown as counts for abbreviation) at different corners (e.g., including FF corner, TT corner and SS corner, wherein definitions thereof are known to the art and thus details thereof are not described herein) corresponding to different temperatures to be measured. Although the width of the temperature signal T_OUTf may be extended by designing a more complicated comparator, a larger area in the chip is required.

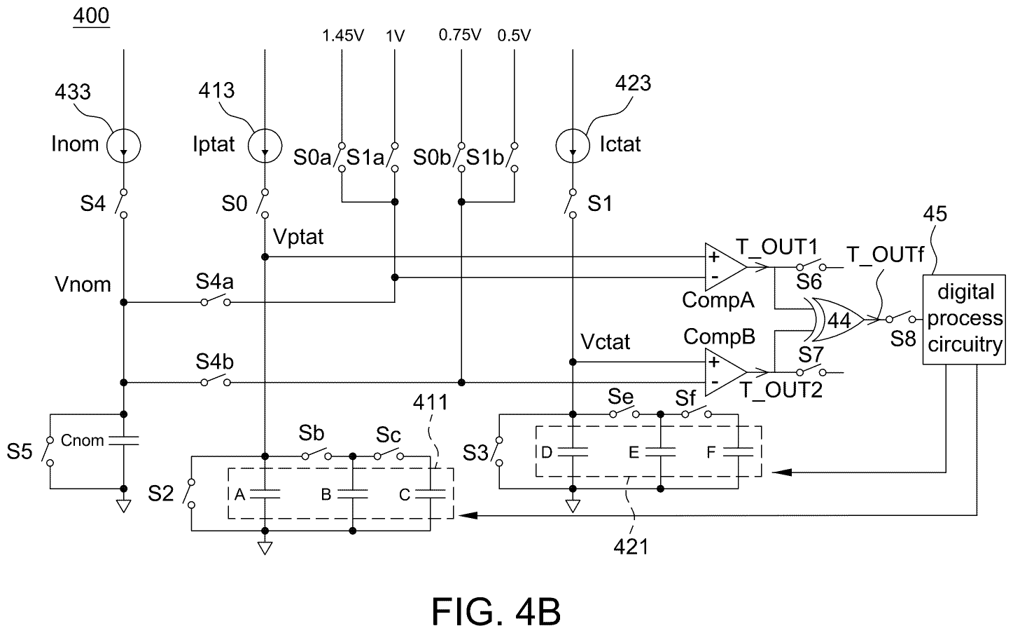

Please refer to FIG. 4A, it is a schematic diagram of a temperature sensor 400 according to a second embodiment of the present disclosure, also including a temperature sensing circuit and a digital processing circuitry 45 coupled to each other. The difference between the temperature sensor 400 and the temperature sensor 100 is that the temperature sensor 400 further includes a calibration circuit for selecting proper capacitance in a calibration mode to cause the counting value of the temperature signal T_OUTf in a measurement mode to be more consistent across wafer fabrication process. Similarly, the digital processing circuitry 45 is used to convert a width of the temperature signal T_OUTf (e.g., referring to FIG. 2B) to a counting value to determine a measured temperature, and is used to control (e.g., including an ASIC or FPGA therein) operations of the temperature sensing circuit (e.g., ON/OFF of switches) in the calibration mode and a measurement mode. Similarly, the digital processing circuitry 45 is located inside or outside a chip of the temperature sensor 400.

The temperature sensing circuit includes a first comparator CompA, a second comparator CompB, a first capacitor bank 411, a first current source 413, a second capacitor bank 421, a second current source 423, a third capacitor Cnom, a third current source 433, switches S0 to S5 (identical to those in FIG. 1), switches S0a to S0d, switches S1a to S1d, switches S4a and S4b, switches S6 to S8 and an XOR gate 44. The XOR gate 44 and the switch S8 are connected between output terminals of the first comparator CompA and the second comparator CompB and the digital processing circuitry 45. The switches S6 and S7 are respectively used to control the first comparator CompA and the second comparator CompB to output a first comparison output T_OUT1 and a second comparison output T_OUT2.

The first capacitor bank 411 includes multiple capacitors A, B and C (e.g., showing 3 capacitors, but not limited to 3) connected in parallel, and the first capacitor bank 411 is coupled to first input terminals, e.g., non-inverting input terminals, of the first comparator CompA and the second comparator CompB. In one aspect, the capacitor A is directly connected to the first input terminal of the first comparator CompA without passing any switch as a default arrangement, but not limited thereto. The second capacitor bank 421 includes multiple capacitors D, E and F (e.g., showing 3 capacitors, but not limited to 3) connected in parallel, and the second capacitor bank 421 is coupled to the first input terminals of the first comparator CompA and the second comparator CompB. In one aspect, the capacitor D is directly connected to the first input terminal of the second comparator CompB without passing any switch as a default arrangement, but not limited thereto.

The first current source 413 is used to charge the first capacitor bank 411 (when switches S0 and S0d are conducted) to a first steady voltage Vptat with a first current Iptat, referring to FIG. 2A. The second current source 423 is used to charge the second capacitor bank 421 (when switches S1 and S1d are conducted) to a second steady voltage Vctat with a second current Ictat, referring to FIG. 2A, wherein the second steady voltage Vctat is lower than the first steady voltage Vptat. The third current source 433 is used to charge the third capacitor Cnom (when switch S4 is conducted and the switch S5 is not conducted) to a third steady voltage Vnom with a third current Inom, referring to FIG. 2A. The switch S4a is connected between the third capacitor Cnom and a second input terminal of the first comparator CompA, and the switch S4b is connected between the third capacitor Cnom and a second input terminal of the second comparator CompB.

The first group of predetermined voltages (e.g., including 1.45 volt and 1 volt, but not limited to) are respectively connected to the second input terminals, e.g., inverting input terminals, of the first comparator CompA and the second comparator CompB via the switches S0a and S0b. The second group of predetermined voltages (e.g., including 0.75 volt and 0.5 volt, but not limited to) are respectively connected to the second input terminals of the first comparator CompA and the second comparator CompB via the switches S1a and S1b. For example, values of the second group of predetermined voltages are smaller than values of the first group of predetermined voltages.

In this embodiment, before shipment, after the charging currents (e.g., Iptat, Ictat) are determined at a predetermined temperature (e.g., 25° C.), values of the first group of predetermined voltages and the second group of predetermined voltages are determined at first, and then capacitance of the multiple capacitors of the first capacitor bank 411 and the second capacitor bank 421 are determined accordingly; or, the capacitance of the multiple capacitors of the first capacitor bank 411 and the second capacitor bank 421 are determined at first, and then values of the first group of predetermined voltages and the second group of predetermined voltages are determined accordingly.

The capacitors A, B and C are identical to or different from one another without particular limitations. The capacitors D, E and F are identical to or different from one another without particular limitations.

The temperature sensor 400 of the present disclosure may be operated in a calibration mode or a measurement mode. In the calibration mode, the switches S4a and S4b are not conducted, and the first group of predetermined voltages and the second group of predetermined voltages are coupled to the second input terminals of the first comparator CompA and the second comparator CompB. The digital processing circuitry 45 selects conducted capacitors in the first capacitor bank 411 and the second capacitor bank 421 according to the first comparison output T_OUT1 and the second comparison output T_OUT2 of the first comparator CompA and the second comparator CompB. In charging the first capacitor bank 411 and the second capacitor bank 421, the switches S2 and S3 are not conducted to keep the voltages.

For example, in the calibration mode, the first capacitor bank 411 is pre-set as the switch Sb conducted and the switch Sc not conducted, and the second capacitor bank 421 is pre-set as the switch Se conducted and the switch Sf not conducted. The switches S4, S4a, S4b and S8 are not conducted, and the switches S6 and S7 are conducted to respectively the first comparison output T_OUT1 and the second comparison out T_OUT2 to the digital processing circuitry 45.

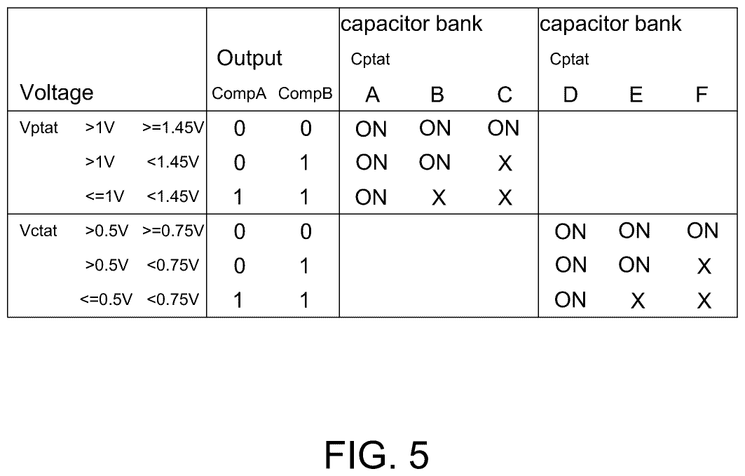

Please refer to FIGS. 4A and 5, when the switches S0, S0a, S0b, S0c and S0d are conducted and when identifying that the first steady voltage Vptat inputted into the first comparator CompA is higher than a first voltage (e.g., 1.45 volt) and the first steady voltage Vptat inputted into the second comparator CompB is higher than a second voltage (e.g., 1 volt) according to the first comparison output T_OUT1 and the second comparison output T_OUT2, the digital processing circuitry 45 increases a number of conducted capacitors in the first capacitor bank 411, e.g., controlling the switch Sb and Sc to be conducted to increase capacitance of the first capacitor bank 411. When the switches S0, S0a, S0b, S0c and S0d are conducted and when identifying that the first steady voltage Vptat inputted into the first comparator CompA is lower than the first voltage and the first steady voltage Vptat inputted into the second comparator CompB is lower than the second voltage according to the first comparison output T_OUT1 and the second comparison output T_OUT2, the digital processing circuitry 45 decreases the number of conducted capacitors in the first capacitor bank 411, e.g., controlling the switch Sb not to be conducted to decrease capacitance of the first capacitor bank 411. When the switches S0, S0a, S0b, S0c and S0d are conducted and when identifying that the first steady voltage Vptat inputted into the first comparator CompA and the second comparator CompB is between the first voltage inputted into the first comparator CompA and the second voltage inputted into the second comparator CompB according to the first comparison output T_OUT1 and the second comparison output T_OUT2, the digital processing circuitry 45 maintains the number of conducted capacitors in the first capacitor bank 411, e.g., keeping the switch Sb conducted and the switch Sc not conducted to maintain capacitance of the first capacitor bank 411. In identifying the conducted capacitors of the first capacitor bank 411, the switch S2 is not conducted.

Please refer to FIGS. 4A and 5 again, when the switches S1, S1a, S1b, S1c and S1d are conducted and when identifying that the second steady voltage Vctat inputted into the first comparator CompA is higher than a third voltage (e.g., 0.75 volt) and the second steady voltage Vctat inputted into the second comparator CompB is higher than a fourth voltage (e.g., 0.5 volt) according to the first comparison output T_OUT1 and the second comparison output T_OUT2, the digital processing circuitry 45 increases a number of conducted capacitors in the second capacitor bank 412, e.g., controlling the switch Se and Sf to be conducted to increase capacitance of the second capacitor bank 412. When the switches S1, S1a, S1b, S1c and S1d are conducted and when identifying that the second steady voltage Vctat inputted into the first comparator CompA is lower than the third voltage and the second steady voltage Vctat inputted into the second comparator CompB is lower than the fourth voltage according to the first comparison output T_OUT1 and the second comparison output T_OUT2, the digital processing circuitry 45 decreases the number of conducted capacitors in the second capacitor bank 412, e.g., controlling the switch Se not to be conducted to decrease capacitance of the second capacitor bank 412. When the switches S1, S1a, S1b, S1c and S1d are conducted and when identifying that the second steady voltage Vctat inputted into the first comparator CompA and the second comparator CompB is between the third voltage inputted into the first comparator CompA and the fourth voltage inputted into the second comparator CompB according to the first comparison output T_OUT1 and the second comparison output T_OUT2, the digital processing circuitry 45 maintains the number of conducted capacitors in the second capacitor bank 412, e.g., keeping the switch Se conducted and the switch Sf not conducted to maintain capacitance of the second capacitor bank 412. In identifying the conducted capacitors of the second capacitor bank 412, the switch S3 is not conducted.

When the calibration mode is accomplished, capacitance of the first capacitor bank 411 and the second capacitor bank 421 (determined according to conducting states of the switches Sb, Sc, Se and Sf) are values cater for the wafer fabrication process variations.

In the measurement mode, the switches S0a, S0b, S1a, S1b, S6 and S7 are not conducted, and the switches S0c, S0d, S1c, S1d, S4a and S4b are conducted to form a connection similar to that of FIG. 1. Meanwhile, in the measurement mode, the connection of capacitors in the first capacitor bank 411 and the second capacitor bank 412 has been decided and is not changed again, and thus the operations thereof are similar to those shown in FIGS. 1 to 3, i.e. the digital processing circuitry 45 determining a measured temperature according to a width of the temperature signal T_OUTf outputted by the temperature sensing circuit identical to FIG. 1 only with changeable capacitance, and thus details thereof are not repeated herein.

Please refer to FIG. 4B, it is another schematic diagram of a temperature sensor 400′ according to a second embodiment of the present disclosure, also including a temperature sensing circuit and a digital processing circuitry 45 coupled to each other. Identical components in the temperature sensor 400 and the temperature sensor 400′ are indicated by the same reference numerals. The temperature sensor 400′ also includes a calibration circuit for selecting proper capacitance in a calibration mode to cause the counting value of the temperature signal T_OUTf in a measurement mode to be more consistent across wafer fabrication process. Similarly, the digital processing circuitry 45 is used to convert a width of the temperature signal T_OUTf (e.g., referring to FIG. 2B) to a counting value to determine a measured temperature, and is used to control (e.g., including an ASIC or FPGA therein) operations of the temperature sensing circuit (e.g., ON/OFF of switches) in the calibration mode and the measurement mode. Similarly, the digital processing circuitry 45 is located inside or outside a chip of the temperature sensor 400′.

The temperature sensing circuit includes a first comparator CompA, a second comparator CompB, a first capacitor bank 411, a first current source 413, a second capacitor bank 421, a second current source 423, a third capacitor Cnom, a third current source 433, switches S0 to S5 (identical to those in FIG. 1), switches S0a and S1a, switches S0b to S1b, switches S4a and S4b, switches S6 to S8 and an XOR gate 44. The XOR gate 44 and the switch S8 are connected between output terminals of the first comparator CompA and the second comparator CompB and the digital processing circuitry 45. The switches S6 and S7 are respectively used to control the first comparator CompA and the second comparator CompB to output a first comparison output T_OUT1 and a second comparison output T_OUT2.

The first capacitor bank 411 and the second capacitor bank 421 are identical to those in FIG. 4A, and thus details thereof are not repeated herein.

The first current source 413 is used to charge the first capacitor bank 411 (when switch S0 is conducted) to a first steady voltage Vptat with a first current Iptat, referring to FIG. 2A. The second current source 423 is used to charge the second capacitor bank 421 (when switch S1 is conducted) to a second steady voltage Vctat with a second current Ictat, referring to FIG. 2A, wherein the second steady voltage Vctat is lower than the first steady voltage Vptat. The third current source 433 is used to charge the third capacitor Cnom (when switch S4 is conducted and the switch S5 is not conducted) to a third steady voltage Vnom with a third current Inom, referring to FIG. 2A. The switch S4a is connected between the third capacitor Cnom and a second input terminal of the first comparator CompA, and the switch S4b is connected between the third capacitor Cnom and a second input terminal of the second comparator CompB.

The first group of predetermined voltages (e.g., including 1.45 volt and 1 volt, but not limited to) are sequentially connected to the second input terminal, e.g., inverting input terminal, of the first comparator CompA respectively via the switches S0a and Sla. The second group of predetermined voltages (e.g., including 0.75 volt and 0.5 volt, but not limited to) are sequentially connected to the second input terminal of the second comparator CompB respectively via the switches S0b and S1b. For example, values of the second group of predetermined voltages are smaller than values of the first group of predetermined voltages.

The temperature sensor 400 of the present disclosure may also be operated in a calibration mode or a measurement mode. In the calibration mode, the switches S4a and S4b are not conducted, and the first group of predetermined voltages and the second group of predetermined voltages are respectively coupled to the second input terminals of the first comparator CompA and the second comparator CompB. The digital processing circuitry 45 selects conducted capacitors in the first capacitor bank 411 and the second capacitor bank 421 according to the first comparison output T_OUT1 and the second comparison output T_OUT2 of the first comparator CompA and the second comparator CompB. In charging the first capacitor bank 411 and the second capacitor bank 421, the switches S2 and S3 are not conducted to keep the voltages.

For example, in the calibration mode, the first capacitor bank 411 is pre-set as the switch Sb conducted and the switch Sc not conducted, and the second capacitor bank 421 is pre-set as the switch Se conducted and the switch Sf not conducted, but not limited thereto. The switches S4, S4a, S4b and S8 are not conducted, and the switches S6 and S7 are conducted to respectively the first comparison output T_OUT1 and the second comparison out T_OUT2 to the digital processing circuitry 45.

Please refer to FIGS. 4B and 5, when the switches S0, S1, S0a and S0b are conducted and when identifying that the first steady voltage Vptat inputted into the first comparator CompA is higher than a first voltage (e.g., 1.45 volt) and the second steady voltage Vctat inputted into the second comparator CompB is higher than a third voltage (e.g., 0.75 volt) according to the first comparison output T_OUT1 and the second comparison output T_OUT2, the digital processing circuitry 45 increases a number of conducted capacitors in the first capacitor bank 411 and the second capacitor bank 412, e.g., controlling the switch Sb and Sc to be conducted to increase capacitance of the first capacitor bank 411 controlling the switch Se and Sf to be conducted to increase capacitance of the second capacitor bank 421. When the switches S0, S1, S0a and S0b are conducted and when identifying that the first steady voltage Vptat inputted into the first comparator CompA is lower than the first voltage and the second steady voltage Vctat inputted into the second comparator CompB is lower than the third voltage according to the first comparison output T_OUT1 and the second comparison output T_OUT2, the switches S0, S1, Sla and S1b are conducted and the switches S0a and S0b are disconnected.

When the switches S0, S1, Sla and S1b are conducted and when identifying that the first steady voltage Vptat inputted into the first comparator CompA is lower than a second voltage (e.g., 1 volt) and the second steady voltage Vctat inputted into the second comparator CompB is lower than a fourth voltage (e.g., 0.5 volt) according to the first comparison output T_OUT1 and the second comparison output T_OUT2, the digital processing circuitry 45 decreases a number of conducted capacitors in the first capacitor bank 411 and the second capacitor bank 412, e.g., controlling the switch Sb to be disconnected to decrease capacitance of the first capacitor bank 411 and controlling the switch Se to be disconnected to decrease capacitance of the second capacitor bank 421.

When the switches S0, S1, Sla and S1b are conducted and when identifying that the first steady voltage Vptat inputted into the first comparator CompA is between the first voltage and the second voltage (e.g., 1 volt) and the second steady voltage Vctat inputted into the second comparator CompB is between the third voltage and the fourth voltage according to the first comparison output T_OUT1 and the second comparison output T_OUT2, the digital processing circuitry 45 maintains the number of conducted capacitors in the first capacitor bank 411 and the second capacitor bank 412, e.g., controlling the switch Sb conducted and the switch Sc to be disconnected to maintain capacitance of the first capacitor bank 411 and controlling the switch Se conducted and the switch Sf to be disconnected to maintain capacitance of the second capacitor bank 421.

When the calibration mode is accomplished, capacitance of the first capacitor bank 411 and the second capacitor bank 421 (determined according to conducting states of the switches Sb, Sc, Se and Sf) are values cater for the wafer fabrication process variations.

In the measurement mode, the switches S0a, S0b, S1a, S1b, S6 and S7 are not conducted, and the switches S4a and S4b are conducted to form a connection similar to that of FIG. 1. Meanwhile, in the measurement mode, the connection of capacitors in the first capacitor bank 411 and the second capacitor bank 412 has been decided and is not changed again, and thus the operations thereof are similar to those shown in FIGS. 1 to 3, i.e. the digital processing circuitry 45 determining a measured temperature according to a width of the temperature signal T_OUTf outputted by the temperature sensing circuit identical to FIG. 1 only with changeable capacitance, and thus details thereof are not repeated herein.

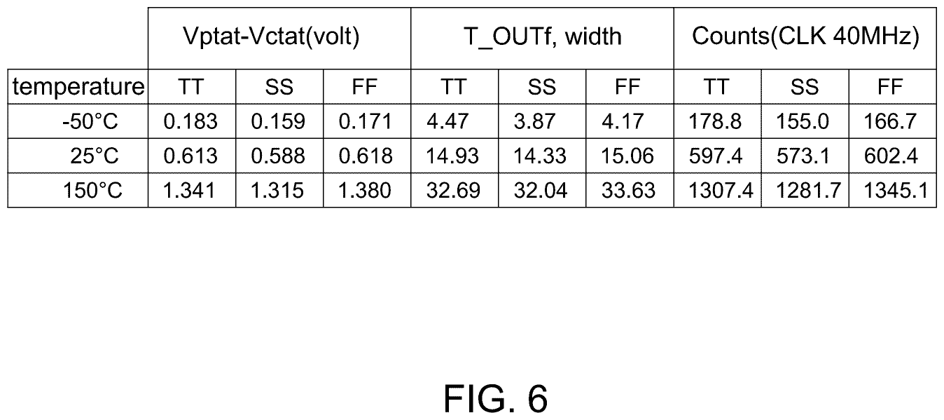

Please refer to FIG. 6, by using the calibration mode to select capacitance of the first capacitor bank 411 and the second capacitor bank 421 previously, the width of the temperature signal T_OUTf is increased (e.g., compared to FIG. 3) and more consistent, and thus the measurement accuracy at low temperature is increased.

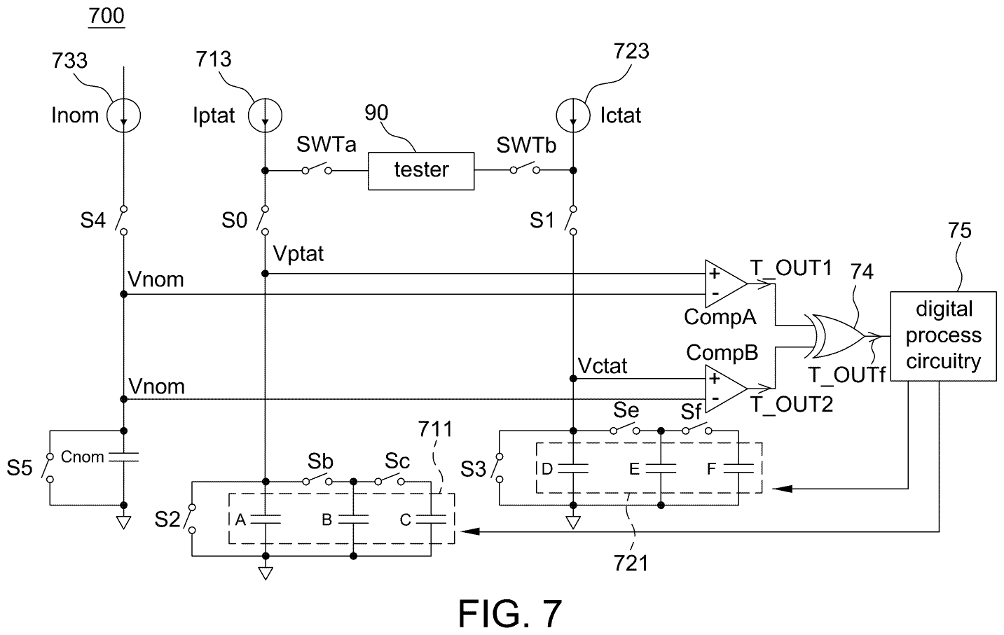

Please refer to FIG. 7, it is a schematic diagram of a temperature sensor 700 according to a third embodiment of the present disclosure, also including a temperature sensing circuit and a digital processing circuitry 75 coupled to each other. The difference between the temperature sensor 700 and the temperature sensor 100 is that the temperature sensor 700 includes a first capacitor bank 711 and a second capacitor bank 721 so as to determine a proper capacitance thereof in a calibration mode. The difference between the temperature sensor 700 and the temperature sensor 400 and 400′ is that the temperature sensor 700 directly readouts the first current Iptat and the second current Ictat for respectively charging the first capacitor bank 711 and the second capacitor bank 721 in the calibration mode by an external tester 90, wherein the first capacitor bank 711 and the second capacitor bank 721 are respectively arranged identical to the first capacitor bank 411 and the second capacitor bank 421 in FIG. 4A, and thus details thereof are not repeated again.

The digital processing circuitry 75 is also used to convert a width of the temperature signal T_OUTf (e.g., referring to FIG. 2B) to a counting value to determine a measured temperature, and is used to control (e.g., including an ASIC or FPGA therein) operations of the temperature sensing circuit (e.g., ON/OFF of switches). The digital processing circuitry 75 is located outside or inside a chip of the temperature sensor 700.

The temperature sensing circuit includes a first comparator CompA, a second comparator CompB, a first capacitor bank 711, a first current source 713, a second capacitor bank 721, a second current source 723, a third capacitor Cnom, a third current source 733, switches S0 to S5 (identical to those in FIG. 1) and an XOR gate 74. The XOR gate 74 is connected between output terminals of the first comparator CompA and the second comparator CompB and the digital processing circuitry 75.

The first capacitor bank 711 is coupled to a first input terminal, e.g., non-inverting input terminal, of the first comparator CompA. The second capacitor bank 721 is coupled to a first input terminal, e.g., non-inverting input terminal, of the second comparator CompB. The third capacitor Cnom is coupled to second input terminals, e.g., inverting input terminals, of the first comparator CompA and the second comparator CompB.

The first current source 713 is used to charge the first capacitor bank 11 (when switch S0 is conducted and the switch S2 is not conducted) to a first steady voltage Vptat with a first current Iptat, referring to FIG. 2A. The second current source 723 is used to charge the second capacitor bank 721 (when switch S1 is conducted and the switch S3 is not conducted) to a second steady voltage Vctat with a second current Ictat, referring to FIG. 2A, wherein the second steady voltage Vctat is lower than the first steady voltage Vptat. The third current source 733 is used to charge the third capacitor 733 (when switch S4 is conducted and the switch S5 is not conducted) to a third steady voltage Vnom with a third current Inom, referring to FIG. 2A.

In this embodiment, before shipment, after the charging currents (e.g., Iptat, Ictat) are determined at a predetermined temperature (e.g., 25° C.), values of a first group of predetermined voltages and a second group of predetermined voltages are determined at first (e.g., recorded in registers of the digital processing circuitry 75), and then capacitance of the multiple capacitors of the first capacitor bank 711 and the second capacitor bank 721 are determined accordingly; or, the capacitance of the multiple capacitors of the first capacitor bank 711 and the second capacitor bank 721 are determined at first, and then values of the first group of predetermined voltages and the second group of predetermined voltages are determined accordingly. The first group of predetermined voltages and the second group of predetermined voltages are respectively used to be compared with the first steady voltage Vptat and the second steady voltage Vctat.

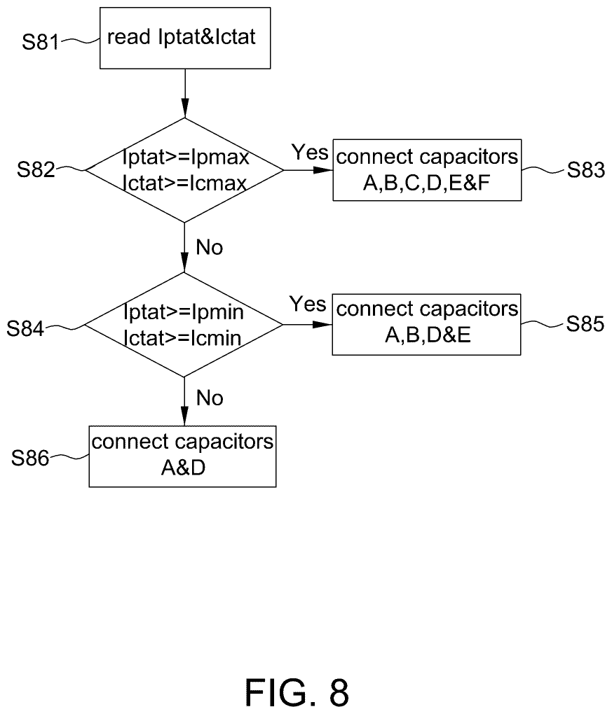

Please refer to FIG. 8, it is a flow chart of an operating method of a temperature sensor 700 according to a third embodiment of the present disclosure. In this embodiment, the calibration is performed outside the chip. For example, Iptat and Ictat are measured by an external tester 90 through switches SWTa and SWTb before temperature measurement starts. By comparing the measured Iptat and Ictat with a predetermined specification, e.g., Iptatmax, Iptatmin, Ictatmax and Ictatmin as shown in FIG. 8, it is able to know that to which process variations that wafers are skewed. The digital process circuitry 75 controls the connection and disconnection of the capacitors A, B, C, D, E and F through programming into the registers for controlling the switches Sb, Sc, Se and Sf.

The tester 90 is used to measure the first current Iptat of the first current source 713 and the second current Ictat of the second capacitor bank 721, Step S81. The tester 90 previously records a first maximum current Iptatmax and a first minimum current Iptatmin associated with the first current Iptat as well as a second maximum current Ictatmax and a second minimum current Ictatmin associated with the second current Ictat.

Next, the tester 90 compares the first current Iptat with the first maximum current Iptatmax and compares the second current Ictat with the second maximum current Ictatmax, Step S82.

Referring to FIG. 8, when identifying that the measured first current Iptat is higher than the first maximum current Iptatmax and the measured second current Ictat is higher than the second maximum current Ictatmax, the digital processing circuitry 75 conducts the switches Sb, Sc, Se and Sf to connect capacitors A, B, C, D, E and F in the temperature measurement, Step S83; when identifying that the measured first current Iptat is higher than the first minimum current Iptatmin (not higher than Iptatmax) and the measured second current Ictat is higher than the second minimum current Ictatmin (not higher than Ictatmax), the digital processing circuitry 75 conducts the switches Sb and Se to connect capacitors A, B, D and E in the temperature measurement, Step S85; and when identifying that the measured first current Iptat is not higher than the first minimum current Iptatmin and the measured second current Ictat is not higher than the second minimum current Ictatmin, the digital processing circuitry 75 does not conduct any of the switches Sb, Sc, Se and Sf such that only the capacitors A and D are connected in the temperature measurement, Step S86.

In other aspects, the first capacitor bank 711 is pre-set as the switches Sb and Sc being both conducted or non-conducted, and the first capacitor bank 721 is pre-set as the switches Se and Sf being both conducted or non-conducted as long as current thresholds corresponding to the first current Iptat and the second current Ictat are predetermined and recorded in the tester 90.

It should be mentioned that although the present disclosure is described in the way that the voltage Vnom is coupled to the inverting input terminal of comparators, and the voltages Vptat and Vctat are coupled to non-inverting input terminals of the comparators, the present disclosure is not limited thereto. In another aspect, the voltage Vnom is coupled to the non-inverting input terminal of comparators, and the voltages Vptat and Vctat are coupled to inverting input terminals of the comparators, and T_OUT1 and T_OUT2 are inputted into the XOR gate, and the same effectiveness is achieved. In a further aspect, the XOR gate is arranged in the digital processing circuitry 15, 45 and 75, i.e. the temperature sensor not including the XOR gate, and the chip of the temperature sensor directly outputs T_OUT1 and T_OUT2 to the digital processing circuitry 15, 45 and 75.

It should be mentioned that although the present disclosure is described in the way that each capacitor banks includes three capacitors, the present disclosure is not limited thereto. It is possible to arrange more than three capacitors in the capacitor banks (with corresponding switching devices and thresholds) to improve the accuracy of temperature measurement.

It should be mentioned that the values, including the clock frequency, voltage values, temperature values and counting values mentioned above are only intended to illustrate but not to limit the present disclosure.

As mentioned above, the traditional temperature sensor has the problem that the measurement accuracy of temperature values is influenced by variations of wafer fabrication process and temperatures to be measured. Accordingly, the present disclosure further provides a temperature sensor (e.g., referring to FIGS. 4A-4B and 7), and an operating method thereof (e.g., referring to FIG. 8). Before measuring temperatures, steady voltages or charging currents of capacitor banks are measured at first to accordingly determine capacitance of the capacitor banks (e.g., recorded programming values in registers) in a measurement mode. In this way, the steady voltages across the wafer fabrication process are more consistent and predictable. Meanwhile, the design complexity and occupied area of the comparators are not required to be increased.

Although the disclosure has been explained in relation to its preferred embodiment, it is not used to limit the disclosure. It is to be understood that many other possible modifications and variations can be made by those skilled in the art without departing from the spirit and scope of the disclosure as hereinafter claimed.

1. A temperature sensor, comprising:
a first comparator;
a second comparator;
a first capacitor bank, coupled to first input terminals of the first comparator and the second comparator;
a second capacitor bank, coupled to the first input terminals of the first comparator and the second comparator;
a first current source, configured to charge the first capacitor bank using a first current;
a second current source, configured to charge the second capacitor bank using a second current;
a first group of predetermined voltages, configured to be coupled to second input terminals of the first comparator and the second comparator; and
a second group of predetermined voltages, configured to be coupled to the second input terminals of the first comparator and the second comparator.

2. The temperature sensor as claimed in claim 1, wherein
the first input terminals of the first comparator and the second comparator are non-inverting input terminals, and
the second input terminals of the first comparator and the second comparator are inverting input terminals.

3. The temperature sensor as claimed in claim 1, further comprising a digital processing circuitry, wherein the digital processing circuitry is configured to select conducted capacitors in the first capacitor bank and the second capacitor bank according to comparison results of the first comparator and the second comparator.

4. The temperature sensor as claimed in claim 3, further comprising an XOR gate connected between output terminals of the first and second comparators and the digital processing circuitry.

5. The temperature sensor as claimed in claim 3, wherein
the first current is configured to charge the first capacitor bank to a first steady voltage,
the first group of predetermined voltages comprise a first voltage and a second voltage lower than the first voltage, and
the digital processing circuitry is configured to
increase a number of conducted capacitors in the first capacitor bank upon identifying that the first steady voltage inputted into the first comparator is higher than the first voltage and the first steady voltage inputted into the second comparator is higher than the second voltage,
decrease the number of conducted capacitors in the first capacitor bank upon identifying that the first steady voltage inputted into the first comparator is lower than the first voltage and the first steady voltage inputted into the second comparator is lower than the second voltage, and
maintain the number of conducted capacitors in the first capacitor bank upon identifying that the first steady voltage inputted into the first comparator and the second comparator is between the first voltage inputted into the first comparator and the second voltage inputted into the second comparator.

6. The temperature sensor as claimed in claim 5, wherein
the second current is configured to charge the second capacitor bank to a second steady voltage,
the second group of predetermined voltages comprise a third voltage and a fourth voltage lower than the third voltage, and
the digital processing circuitry is further configured to
increase a number of conducted capacitors in the second capacitor bank upon identifying that the second steady voltage inputted into the first comparator is higher than the third voltage and the second steady voltage inputted into the second comparator is higher than the fourth voltage,
decrease the number of conducted capacitors in the second capacitor bank upon identifying that the second steady voltage inputted into the first comparator is lower than the third voltage and the second steady voltage inputted into the second comparator is lower than the fourth voltage, and
maintain the number of conducted capacitors in the second capacitor bank upon identifying that the second steady voltage inputted into the first comparator and the second comparator is between the third voltage inputted into the first comparator and the fourth voltage inputted into the second comparator.

7. The temperature sensor as claimed in claim 6, wherein
the second steady voltage is lower than the first steady voltage, and
the second group of predetermined voltages is lower than the first group of predetermined voltages.

8. The temperature sensor as claimed in claim 1, further comprising:
a third capacitor;
a third current source, configured to charge the third capacitor using a third current; and
a group of switches, coupled between the third capacitor and the second input terminals of the first and second comparators.

9. The temperature sensor as claimed in claim 8, wherein the group of switches is not conducted upon the first group of predetermined voltages and the second group of predetermined voltages being coupled to the second input terminals of the first and second comparators.

10. A temperature sensor, comprising:
a first comparator;
a second comparator;
a first capacitor bank, coupled to a first input terminal of the first comparator;
a second capacitor bank, coupled to a first input terminal of the second comparator;
a first current source, configured to charge the first capacitor bank using a first current;
a second current source, configured to charge the second capacitor bank using a second current;
a first group of predetermined voltages, configured to be coupled to a second input terminal of the first comparator; and
a second group of predetermined voltages, configured to be coupled to a second input terminal of the second comparator.

11. The temperature sensor as claimed in claim 10, wherein
the first input terminals of the first comparator and the second comparator are non-inverting input terminals, and
the second input terminals of the first comparator and the second comparator are inverting input terminals.

12. The temperature sensor as claimed in claim 10, further comprising a digital processing circuitry, wherein the digital processing circuitry is configured to select conducted capacitors in the first capacitor bank and the second capacitor bank according to comparison results of the first comparator and the second comparator.

13. The temperature sensor as claimed in claim 12, further comprising an XOR gate connected between output terminals of the first and second comparators and the digital processing circuitry.

14. The temperature sensor as claimed in claim 12, wherein
the first current is configured to charge the first capacitor bank to a first steady voltage,
the first group of predetermined voltages comprise a first voltage and a second voltage lower than the first voltage, and
the digital processing circuitry is configured to
increase a number of conducted capacitors in the first capacitor bank upon identifying that the first steady voltage inputted into the first comparator is higher than the first voltage,
decrease the number of conducted capacitors in the first capacitor bank upon identifying that the first steady voltage inputted into the first comparator is lower than the second voltage, and
maintain the number of conducted capacitors in the first capacitor bank upon identifying that the first steady voltage inputted into the first comparator is between the first voltage and the second voltage.

15. The temperature sensor as claimed in claim 14, wherein
the second current is configured to charge the second capacitor bank to a second steady voltage,
the second group of predetermined voltages comprise a third voltage and a fourth voltage lower than the third voltage, and
the digital processing circuitry is further configured to
increase a number of conducted capacitors in the second capacitor bank upon identifying that the second steady voltage inputted into the second comparator is higher than the third voltage,
decrease the number of conducted capacitors in the second capacitor bank upon identifying that the second steady voltage inputted into the first comparator is lower than the fourth voltage, and
maintain the number of conducted capacitors in the second capacitor bank upon identifying that the second steady voltage inputted into the second comparator is between the third voltage and the fourth voltage.

16. The temperature sensor as claimed in claim 15, wherein
the second steady voltage is lower than the first steady voltage, and
the second group of predetermined voltages is lower than the first group of predetermined voltages.

17. The temperature sensor as claimed in claim 10, further comprising:
a third capacitor;
a third current source, configured to charge the third capacitor using a third current; and
a group of switches, coupled between the third capacitor and the second input terminals of the first and second comparators.

18. The temperature sensor as claimed in claim 17, wherein the group of switches is not conducted upon the first group of predetermined voltages and the second group of predetermined voltages being coupled to the second input terminals of the first and second comparators.

19. An operating method of a temperature sensor, the temperature sensor comprising a first capacitor bank, a second capacitor bank, a first current source and a second current source, and the operating method comprising:
measuring a first current of the first current source and a second current of the second current source respectively using a tester;
conducting first parts of capacitors in the first capacitor bank and the second capacitor bank in temperature measurement upon the first current being larger than a first maximum current and the second current being larger than a second maximum current; and
conducting second parts of capacitors, different from the first parts of capacitors, in the first capacitor bank and the second capacitor bank in the temperature measurement upon the first current being smaller than a first minimum current and the second current being smaller than a minimum maximum current.

20. The operating method as claimed in claim 19, wherein the tester is arranged outside of a chip of the temperature sensor.
